(19) United States
(12) Patent Application Publication
(10) Pub. No.: US 2008/0156645 A1
(43) Pub. Date: Jul. 3, 2008

(54) ERYTHROCYTE SEDIMENTATION RATE LOG

(75) Inventors: Duckjong Kim, Yuseong-gu (KR); Yu Chang Kim, Yuseong-gu (KR); Yun Wook Hwang, Yuseong-gu (KR); Sang-Jin Park, Yuseong-gu (KR); Pil Woo Heo, Yuseong-gu (KR); Eui Soo Yoon, Yuseong-gu (KR)

Correspondence Address: OBLON, SPIVAK, MCCLELLAND MAIER & NEUSTADT, P.C., 1940 DUKE STREET, ALEXANDRIA, VA, 22314, US

(73) Assignee: Korea Institute of Machinery & Materials, Yuseong-gu (KR)

(21) Appl. No.: 11/926,584

(22) Filed: Oct. 29, 2007

(30) Foreign Application Priority Data
Dec. 28, 2006 (KR) 10-2006-0136875

(51) Int. Cl. G01N 27/30

(52) U.S. Cl. 204/403.01; 324/71.4

(57) ABSTRACT

An erythrocyte sedimentation rate log capable of quickly and easily measuring an erythrocyte sedimentation rate in the blood by measuring the number of erythrocytes in the blood passing through a branched channel from a small amount of blood in an electrical manner without an additional driving means is disclosed. The erythrocyte sedimentation rate log includes a main body formed of an upper plate and a lower plate, a blood introduction part formed in the main body to include an inlet and an outlet formed at one side of the upper plate of the main body, a channel disposed at one side of the blood introduction part to communicate with the blood introduction part such that erythrocytes in blood pass through the channel, and a current supply part installed in the channel to supply constant current to cause an electrical resistance in erythrocytes.

### BACKGROUND OF THE INVENTION

1. Field of the Invention

The present invention relates to an erythrocyte sedimentation rate log, and more particularly to an erythrocyte sedimentation rate log capable of quickly and easily measuring an erythrocyte sedimentation rate in the blood by measuring the number of erythrocytes in the blood passing through a branched channel from a small amount of blood in an electrical manner without an additional driving means.

2. Description of the Related Art

Generally, the blood mainly includes solid corpuscles and liquid blood plasma surrounding the corpuscles and, particularly, the corpuscles include red corpuscles, white corpuscles and blood platelets.

Various blood tests have been conducted to diagnose the health state of human or animal. Particularly, erythrocyte sedimentation rate measurement is useful in determining the existence or nonexistence of various diseases such as a malignant tumor, multiple myeloma and advanced phthisis and convalescence to serve as a basic blood test.

As shown in FIGS. 4 and 5, as a method of measuring an erythrocyte sedimentation rate, there are a manual measurement method and an automatic measurement method. In the manual measurement method, extracted blood is mixed with an anticoagulant to be put in test tubes vertically standing up and a sedimentation distance of red corpuscles for one hour is checked to measure the sedimentation rate of the red corpuscles. In the automatic measurement method, the sedimentation rate of the red corpuscles is automatically measured using automated equipment such as optical equipment and a computer.

In the conventional method of measuring the sedimentation rate of red corpuscles, however, the manual measurement method is laborious and inconvenient in measuring the sedimentation rate of red corpuscles within a short period of time sine one hour or more is consumed for a test. The automatic measurement method which has be widely used recently has problems such that miniaturization is disadvantageous, measurement equipment is expensive due to the use of high-priced optical equipment, it is difficult for an individual to carry, and a large amount of blood is necessary.

### SUMMARY OF THE INVENTION

Therefore, the present invention has been made in view of the above problems, and it is an object of the present invention to provide an erythrocyte sedimentation rate log capable of quickly and easily measuring an erythrocyte sedimentation rate in the blood by measuring the number of erythrocytes in the blood passing through a branched channel from a small amount of blood in an electrical manner without an additional driving means.

Further, it is another object of the present invention to provide an erythrocyte sedimentation rate log capable of being portable and convenient in the movement by simplifying a configuration of equipment and being provided with low cost using a simple system.

In accordance with an aspect of the present invention, there is provided an erythrocyte sedimentation rate log comprising: a main body formed of an upper plate and a lower plate; a blood introduction part formed in the main body to include an inlet and an outlet formed at one side of the upper plate of the main body; a channel disposed at one side of the blood introduction part to communicate with the blood introduction part such that erythrocytes in blood pass through the channel; and a current supply part installed in the channel to supply constant current to cause an electrical resistance in erythrocytes.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates a perspective view showing an erythrocyte sedimentation rate log according to the present invention;

FIG. 2 illustrates a cross-sectional view taken along a line A-A of FIG. 1;

FIG. 3 illustrates a cross-sectional view taken along a line B-B of FIG. 1; and

FIGS. 4 and 5 show a conventional method of measuring an erythrocyte sedimentation rate.

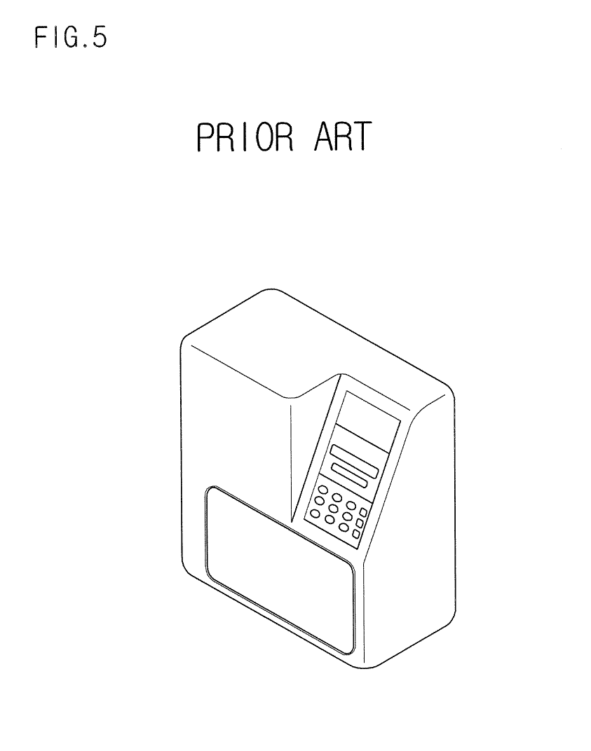

### DETAILED DESCRIPTION OF THE PREFERRED EMBODIMENTS

Hereinafter, preferred embodiments of the present invention will be described in detail with reference to the accompanying drawings.

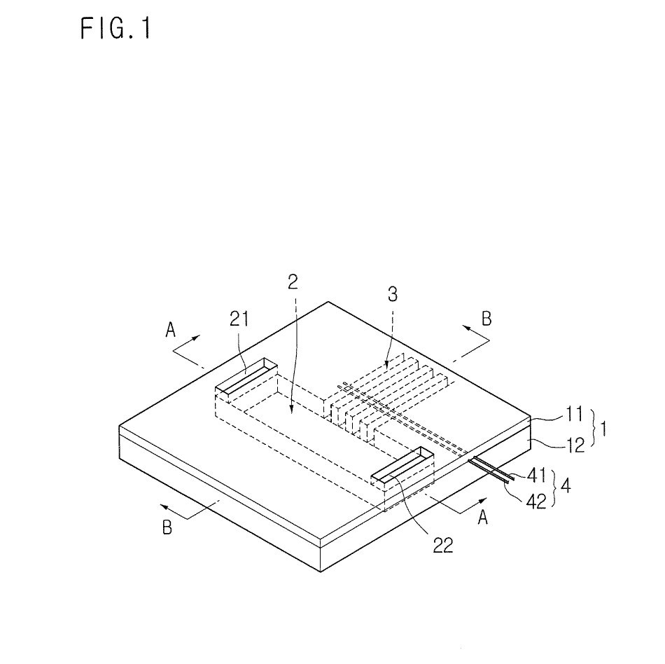

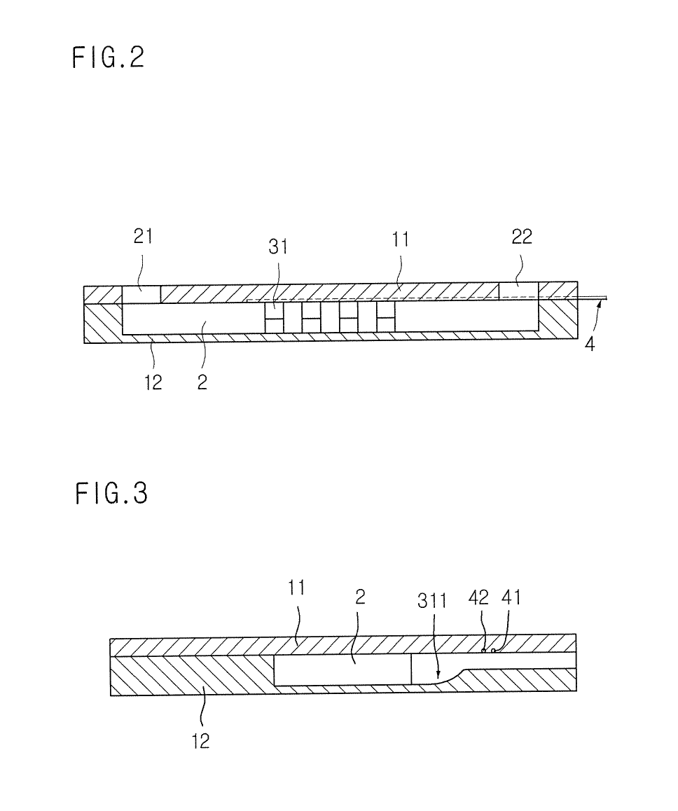

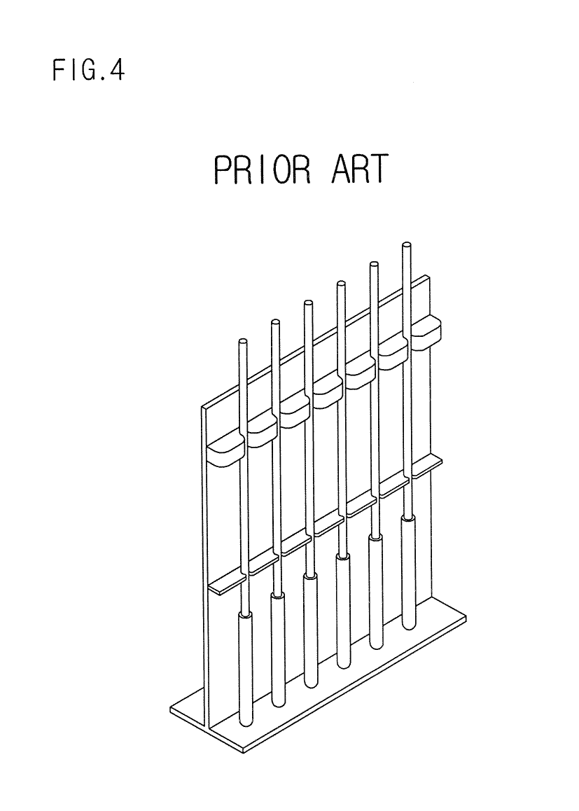

FIG. 1 illustrates a perspective view showing an erythrocyte sedimentation rate log according to the present invention. FIG. 2 illustrates a cross-sectional view taken along a line A-A of FIG. 1. FIG. 3 illustrates a cross-sectional view taken along a line B-B of FIG. 1.

As shown in FIGS. 1 to 3, the erythrocyte sedimentation rate log according to the present invention includes a main body 1 formed of an upper plate 11 and a lower plate 12, a blood introduction part 2 formed in the main body 1 to include an inlet 21 and an outlet 22 formed at one side of the upper plate 11 of the main body 1, a channel 3 disposed at one side of the blood introduction part 2 to communicate with the blood introduction part 2 such that erythrocytes in the blood pass through the channel 3, and a current supply part 4 installed in the channel 3 to supply constant current to cause an electrical resistance in the erythrocytes.

Particularly, the current supply part 4 includes electrodes 41 and 42 disposed at the upper plate 11 which covers an upper portion of the channel 3.

Further, the channel 3 is configured as a number of groove portions 31 arranged in a flowing direction.

Further, depressed groove portions 311 of a curved surface shape are formed in the groove portions 31 such that the erythrocytes are smoothly separated without damage.

Meanwhile, a detector is used to detect the number of erythrocytes based on voltage values changed according to the electrical resistance due to the erythrocytes in the current supply part 4.

The detector converts the voltage values obtained by causing the electrical resistance in the erythrocytes by the current supply part 4 into computer signals. The detector analyzes the computer signals to obtain the information on the number of the erythrocytes passing through the channel 3. The erythrocyte sedimentation rate is measured from the fact that the number of the erythrocytes passing through the channel 3 is reduced as the erythrocyte sedimentation rate is large.

Particularly, the main body 1 is formed of a transparent plate to check the inside thereof with the naked eye.

Further, the blood introduction part 2 corresponds to a space portion formed in the center of the main body 1.

Further, preferably, the channel 3 is formed to have the height of about 3 μm and the width of about 10 μm to allow smooth movement of erythrocytes. The channel 3 is formed in a longitudinal direction from an upper end of the sidewall of the blood introduction part 2 to the rear side of an upper portion of the main body 1.

Hereinafter, an operation of the erythrocyte sedimentation rate log according to the present invention will be described.

As shown in FIGS. 1 to 3, first, if the blood is introduced into the inlet 21 of the blood introduction part 2, the erythrocytes sink and some of the erythrocytes existing at an upper portion of the blood introduction part 2 are introduced into the channel 3 while the blood moves to the outlet 22 due to a capillary phenomenon.

In this case, since the number of the erythrocytes existing at an upper portion of the blood introduction part 2 is reduced as the erythrocyte sedimentation rate is large, the number of the erythrocytes introduced into the channel 3 is reduced.

In order to measure the number of the erythrocytes passing through the channel 3, constant current is supplied to the blood by the current supply part 4 installed in the channel 3 of the main body 1. At a moment when the erythrocytes pass through electrodes 41 and 42, a potential difference between the electrodes 41 and 42 due to the electrical resistance of the erythrocytes becomes large to obtain voltage signals of a pulse form.

If the number of the pulse signals is detected by the detector to obtain the information on the number of the erythrocytes passing through the channel 3, it is possible to calculate the erythrocyte sedimentation rate in inverse proportion thereto.

Thus, in the erythrocyte sedimentation rate log according to the present invention, since a very short period of time of several seconds or less is consumed in the blood movement, the time required for the measurement is very short. Since a drop of the blood is sufficient, it is possible to easily and conveniently determine the existence or nonexistence of various diseases and convalescence in the field. Thus, the erythrocyte sedimentation rate log can be applied to a field diagnostic apparatus.

As described above, the erythrocyte sedimentation rate log according to the present invention has an effect of easily and conveniently measuring the erythrocyte sedimentation rate in the blood by measuring the number of the erythrocytes in the blood passing through the branched channel from a small amount of blood in an electrical manner without an additional driving means.

Further, since a configuration of the apparatus is simple, it is portable and convenient in the movement. Furthermore, it can be provided with low cost due to the simple system.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. An erythrocyte sedimentation rate log comprising:
a main body formed of an upper plate and a lower plate;
a blood introduction part formed in the main body to include an inlet and an outlet formed at one side of the upper plate of the main body;
a channel disposed at one side of the blood introduction part to communicate with the blood introduction part such that erythrocytes in blood pass through the channel; and
a current supply part installed in the channel to supply constant current to cause an electrical resistance in erythrocytes.

2. The erythrocyte sedimentation rate log according to claim 1, wherein the current supply part includes electrodes and disposed at an upper portion of the channel.

3. The erythrocyte sedimentation rate log according to claim 1, wherein the channel includes a number of groove portions arranged in a flowing direction.

4. The erythrocyte sedimentation rate log according to claim 3, wherein depressed groove portions of a curved surface shape are formed in the groove portions such that the erythrocytes are smoothly separated without damage.

5. The erythrocyte sedimentation rate log according to claim 2, wherein the channel includes a number of groove portions arranged in a flowing direction.

6. The erythrocyte sedimentation rate log according to claim 5, wherein depressed groove portions of a curved surface shape are formed in the groove portions such that the erythrocytes are smoothly separated without damage.
